(19) United States
(12) Patent Application Publication
(10) Pub. No.: US 2006/0196513 A1
(43) Pub. Date: Sep. 7, 2006

(54) Triple hopper max with built-in granulated cavity filling capability

(75) Inventors: Charles Gary Atwell, Mechanicsville, VA (US); Eric Donald Schardt, Powhatan, VA (US)

Correspondence Address: CONNOLLY BOVE LODGE & HUTZ, LLP, P O BOX 2207, WILMINGTON, DE, 19899, US

(73) Assignee: Philip Morris USA Inc.

(21) Appl. No.: 11/315,533

(22) Filed: Dec. 22, 2005

Related U.S. Application Data
(60) Provisional application No. 60/640,372, filed on Dec. 30, 2004.

(51) Int. Cl. B31C 13/00; A24C 1/26

(52) U.S. Cl. 131/58; 493/39

(57) ABSTRACT

Methods and apparatus for forming smoking products include a triple hopper for forming filter components of multiple sizes. The filter components are partially wrapped, and at a downstream location granular media is dispended onto the partially wrapped components. A cover cap is placed over the partially wrapped components to thereby form a complete wrap. Subsequently, the fully wrapped filter components may be joined to tobacco rods with tipping paper.

### CROSS REFERENCE RELATED TO APPLICATION

The present application claims the benefit of provisional application Ser. No. 60/640,372, filed Dec. 30, 2004, for all useful purposes, and the specification and drawings thereof are included herein by reference.

### BACKGROUND OF THE INVENTION

Production lines for tobacco products often involve processing rod shaped articles either continuously or through a series of drums to obtain a desired final result. Such a production line can comprise a plain cigarette processing apparatus (a cigarette rod maker or “maker”), such as by way of example a machine that is available from Hauni Machinenbau AG of Hamburg, Germany under the trade name PROTOS, a filter rod apparatus (“tipping machine”), such as by way of example a machine that is available from Hauni Machinenbau AG of Hamburg, Germany under the trade name MAX, and a packing machine.

U.S. Pat. No. 3,306,306 to Rudszinat teaches a well known two hopper design for the production of filter components. Standard sized filter rods are fed from two hoppers to a series of cutting, staggering, spreading and alignment drums. Depending on which hopper and corresponding drums the filter passes though, filters of a first or second size will be produced.

U.S. Pat. No. 4,815,481 to Hirose et al. also teaches a two hopper design for feeding filter tips and tip halves through machinery to join these two components together with cigarettes.

U.S. Pat. No. 3,308,832 to Stelzer et al. discloses a method of production for forming filter mouthpieces of ultimate or unit length comprising two rod shaped outer filters of identical material and intermediate or inner filters of granular material. Also disclosed is a method and apparatus for forming multiple intermediate filters of a unit length to form a more complex filter.

U.S. Patent Application Publication 2003/0034085 teaches an apparatus and method for filling cavities with metered amounts of granulated particles.

One of the limitations of the prior technologies used to combine filter components is the registration (positions) of the components to each other as well as to the final cut of the filter assembly. The process of transferring multiple components into the serial stream often results in unintentional gaps, components having the wrong lengths, or the total lack of a component being present. In addition to these issues, once the serial filter assembly is wrapped and sealed in a paper, the continuous serial filter assembly is then cut into lengths. This cutting process creates two additional areas where non-conforming products are produced: cut registration and overall filter length. In contrast, the present invention provides techniques which eliminate most if not all of these issues. While the issue of unintentional gaps between components is not completely eliminated in these technologies, the impact on the finished product will be minimized. In prior processes, unintentional gaps between filter components cause the entire serial stream to change position and could affect the final cut registration. In contrast, the process provided by the present invention ensures that the inconsistent assembly of components will only affect the one filter assembly. Inspection techniques will allow the non-conforming assemblies to be identified and removed.

Furthermore, according to prior techniques for the filling of cavities, the possibility of these particles ending up trapped outside the pocket region but under the filter wrap exceeds acceptable limits. These particles would be rendered visible to the consumer by, for instance, ending up in an area near the exposed end of the filter when it is combined with the cigarette and wrapped with tipping paper. The prior art used several different methods to eliminate this possibility. Techniques to inspect filters for this scatter or combining the filter assembly with an additional solid acetate filter component to cap the end of the product, are examples of two methods used in the prior art. Both of these methods are expensive, increase production waste, and complicate the entire manufacturing process.

The techniques provided by the present invention achieve almost elimination of particle scatter. Because the first paper wrap is attached to the filter component assembly prior to the cavity filling process, the possibility for the particles to be trapped between the paper and the filter components is minimized. While it is not guaranteed that all of the particles transferred from the drum end up in the cavity, there is no area where the particle can come to rest on the surface of the filter assembly. Once the paper cap is applied, the particles are retained in the cavities.

Prior methods for the assembly of combined filters are also limited by several factors relating to productivity. In the process of combining two different components to make a plug filter assembly, the techniques used to transfer the assembly into a serial stream so paper can be applied and the filter assembly cut are normally limited to less than 400 meters per minute. As the makeup of the components increases in complexity or the addition of cavities filled with particles are introduced, this maximum speed drops to less than 250 meters per minute. Using a typical 108-millimeter filter as an example, these prior processes can produce 1,900 to 3,800 filter assemblies per minute, the limiting factor being the ability to deliver particles from the delivery drum to the cavities. Past experience indicates that these prior processes can operate effectively and efficiently up to linear speeds of 300 meters per minute. In contrast, the present invention provides a parallel method that can produce up to 8,000 filters per minute.

Finally, the present invention provides a process which significantly reduces material waste, particularly at machine startup and machine stoppage. Waste reductions from minimizing non-conforming filters should also be realized.

In summary, since the known apparatuses and methods lack the ability to form filters with two or more filter component sizes, a need exists to quickly and efficiently form more complex filters, such as those with two or more filter component sizes.

### SUMMARY OF THE INVENTION

It is therefore an object of this invention to create a new filter tip attachment for cigarette making equipment that will assemble multi-component filters with three components and include the capability of combining these filter components with spaces or cavities and then fill these cavities with filtration and/or flavor granules

It is a further object of this invention to eliminate separate free standing combining operations in order to reduce the number of machines in production that manufacture filters. Such elimination would reduce labor and floor space requirements and improve the cost of manufacturing these complex filters.

It is a further object of the invention to provide a media drum to distribute granular filler, powder, flavor enhancer or other desired material between sections of filter components.

It is a further object of the invention to utilize a closing cam to push the outer components inward to fill spaces and align the components with the plug wrap.

The current invention achieves these objectives by providing an apparatus for forming cigarettes comprising a hopper system for forming sets of filter components; a partial wrapping means for partially wrapping the sets of filter components; a media wheel for dispensing media to partially wrapped sets of filter components; a closing cam; and a cutting wheel.

The objectives are also achieved by the inventive method of forming smoking products comprising forming a first filter component of a first size; forming a second filter component of a second size; forming a third filter component of a third filter size; partially wrapping the first, second and third filter components; filling spaces left between the first, second and third filter components with a filler material; completing wrapping the filter components and filler to form a mouthpiece; and attaching a cigarette rod to the wrapped filter.

### BRIEF DESCRIPTION OF THE DRAWINGS

Novel features and advantages of the present invention in addition to those mentioned above will be readily apparent to persons of ordinary skill in the art from a reading of the following detailed description in conjunction with the accompanying drawings wherein similar reference characters refer to similar parts and in which:

FIG. 1 is a schematic front elevational view a tobacco rod making machine, triple hopper and final processing components as arranged during production, according to a preferred embodiment of the present invention;

FIG. 2 is a schematic lay-out illustrating how the Triple Hopper system divides the filter rods into multiple desired lengths, and how the components once received from the triple hopper, are arranged, processed and then joined with tobacco rods, according to a preferred embodiment of the present invention; and

FIG. 3 shows an expanded schematic of a multi component cigarette filter manufacturing process and apparatus, according to a preferred embodiment the present invention.

### DETAILED DESCRIPTION OF THE INVENTION

Although a preferred embodiment is disclosed, the following description is meant to be exemplary and is not intended to limit the scope of the invention.

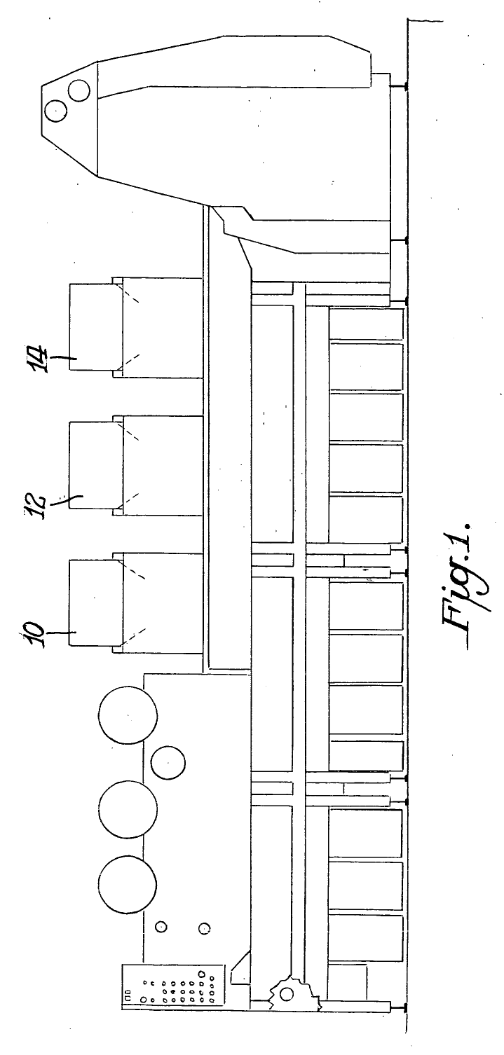

According to an exemplary embodiment, filter components are formed by using three hoppers 10, 12, 14 to produce three unique sized filter components as shown in FIG. 1. Each hopper dispenses 96 mm filter rods. The first hopper produces 16-6 mm components, the second hopper produces 8-12 mm components and the third hopper produces 6-16 mm components. These components are then combined with plug wrap and other media to form a finished filter product.

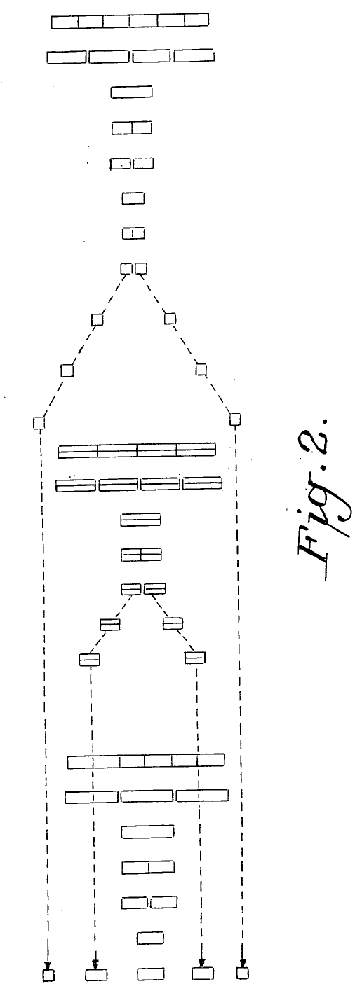

More particularly, the filter component apparatus and method will be described with reference to FIG. 2. In the first hopper 10, filter rods of eight unit lengths (96 mm) are provided. A first cutting wheel (not shown) cuts the rods into four segments of two unit lengths (24 mm) each. The segmented rods of two unit lengths are then fed into an alignment wheel to align the segmented rods serially for further processing. A second cutting wheel (not shown) cuts the filter rods in half to produce two filter rods of single unit length (12 mm). These segments are then fed through another alignment wheel for aligning. The segments are then cut in half yet again to form components of half unit lengths (6 mm). These halves can then be singulated for use as filter components as shown in FIG. 2.

The second hopper 12 is also provided with filter rods of 8 unit lengths (96 mm). A first cutting wheel (not shown) cuts the rods into four segments of two unit lengths (24 mm) each. The segmented rods of two unit lengths are then fed into an alignment wheel to line the segmented rods serially for further processing. A second cutting wheel (not shown) cuts the filter rods in half to produce two filter rods of single unit length (12 mm). These segments of single unit length can then be singulated for use as filter components as shown in FIG. 2.

Filter rods of 8 unit lengths (96 mm) are also provided in the third hopper 14. However, unlike the first two sets of rods, a first cutting wheel (not shown) cuts the rods into three segments of 32 mm each. The segmented rods are then fed into an alignment wheel to line the segmented rods serially for further processing. A second cutting wheel (not shown) cuts the filter rods in half to produce two filter rods of 16 mm. These segments can then be aligned for use as filter components as shown in FIG. 2.

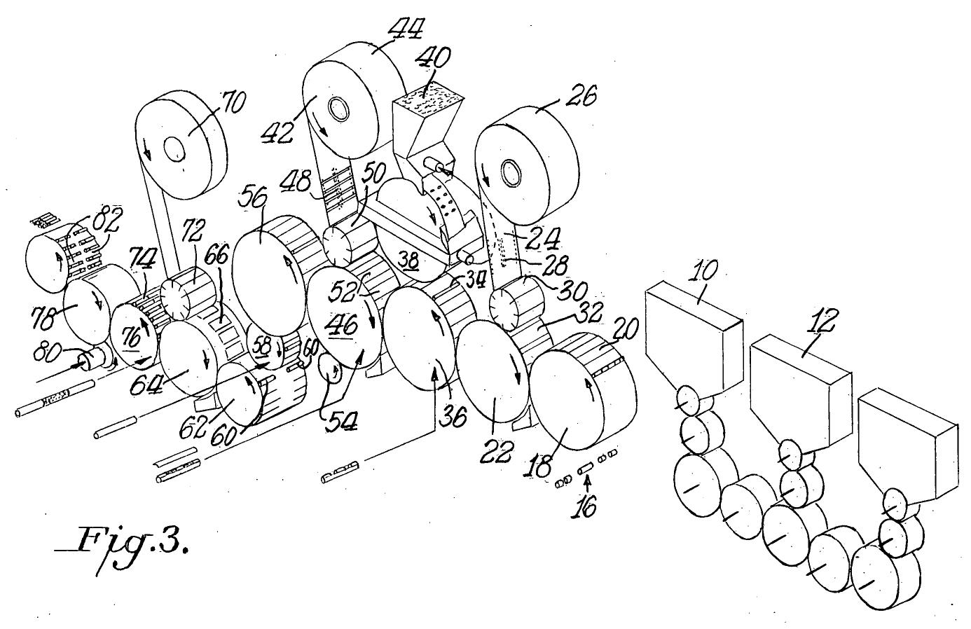

The filter components 16 are then placed on a first drum 18 where they are assembled in a predetermined configuration as shown in FIG. 3. The components are held in place in flutes 20 in the first drum 18 using a vacuum or other securing means and rotatably carried to a second drum 22.

The components are then transferred to the second drum 22 where the components 16 are partially wrapped. Partial wraps are formed by feeding plug wrap 24 from a first plug wrap supply 26 to the second drum. The plug wrap can include patterned glue 28 to assist with the placement and retention of filter components relative to the partial wrap. As the paper meets drum flutes in the second drum, a knife wheel 30 contacts the paper and cuts it into partial wrap patches 32. The filter components 16 are brought in contact with a partial wrap patch 32 to form partially wrapped components 34. The partially wrapped components then travel to a third drum 36 for media introduction.

At this point in the process open space remains between the partially wrapped filter components 16. The open space left in the filter may be positioned to the outside of a drum flute with a vacuum pulling through the porous plug wrap. The partial wraps are carried along the third drum 36 to a vacuum assisted metering drum (or “media wheel”) 38 that may have cavities and flutes aligned with the openings between the filter components 16 in the partial wraps 34. Drum 38 can be designed to accept one or more additives such as granules of carbon and/or flavors to fill the spaces between the filter components. The vacuum assisted metering wheel includes one or more rows of pockets along its periphery which come into communication with a vacuum plenum to draw particles into the pockets as the wheel rotates through a hopper. Upon further rotation, the vacuum is interrupted and the particles are released. An example of a media dispensing wheel is taught by U.S. Patent Application Publication 2003/0034085. A granular media hopper 40 feeds carbon or other media onto the media dispensing wheel. The granules are then transferred by the media wheel to the spaces between the filter components.

Once the spaces are filled with the granules or other media, another piece of plug wrap 42 can be added to the partial wrap 34. In a manner similar to the first plug wrapping operation, a second plug wrap is formed by feeding plug wrap 42 from a second plug wrap supply 44 to a fourth drum 46. The plug wrap can include patterned glue 48 to provide adhesion to the partial wrap 34. As the paper meets the fourth drum 46, a knife wheel 50 contacts the paper, cutting the paper into plug wrap caps 52. The partial wrap 34 contacts the plug wrap cap 52 to form a capped plug wrap. The capped plug wrap then travels to a closing cam 54 to push outer components to fill spaces and align filter components with the plug wrap. Thus, a finished filter is formed with tightly packed components.

The finished filter is then fed via a fifth drum 56 and a sixth drum 58 to be joined with tobacco rods 60. The filters and tobacco rods 60 are aligned on a seventh drum 62 and carried to an eighth drum 64 so that tipping paper can be added.

A tipping patch 66 is added to attach the finished filters to tobacco rods. Tipping patches 66 are formed by feeding tipping paper 68 from a tipping paper supply 70 to the eighth drum 64. As the tipping paper meets the eighth drum, a knife wheel 72 contacts the paper cutting the paper into tipping paper patches 66. Finished filters and tobacco rods are contacted with the tipping paper and folded circumferentially to form tipped double cigarettes 74.

The tipped double cigarette 74 is carried along a ninth drum 76 and a tenth drum 78 where the double cigarette is cut in half at 80 to form two singular cigarettes 82 with the filter ends facing each other. The rods are then fed through a device to align all the cigarettes in the same direction. Thus the cigarettes can be packaged in any predetermined manner.

Although the method and apparatus have been described in detail, this is not meant to limit the invention and one could adjust or alter aspects of the disclosed detailed embodiment without diverging from the scope or spirit of the invention. For instance, other filter component sizes and layouts could be conceived without changing the benefits conferred by the present invention.

What is claimed:

1. An apparatus for forming smoking products comprising:
a hopper system for forming sets of filter components;
partial wrapping means for partially wrapping the sets of filter components;
a media wheel for dispensing media to the sets of partially wrapped filter components;
a closing cam; and
a cutting wheel.

2. An apparatus as in claim 1 wherein the media wheel is constructed and arranged to transfer media to a cavity defined between spaced apart filter components as the components are disposed along a flute of a rotating drum.

3. An apparatus as in claim 1 including multiple rotating drums with longitudinal flutes on the outside of the drums constructed and arranged to hold and transfer the filter components during forming.

4. A method for forming smoking products comprising:
forming a first filter component of a first size;
forming a second filter component of a second size;
forming a third filter component of a third filter size;
partially wrapping the first, second and third filter components;
filling spaces left between the first, second and third filter components with a filler material;
completing wrapping the filter components and filler to form a mouthpiece; and
attaching a tobacco rod to the wrapped filter.

5. A method as in claim 4 wherein at least two of the filter components are essentially the same size.

6. A method as in claim 4 wherein the filling step includes transferring filler material to the spaces between the first, second and third filter components as the components are disposed along a flute of a rotating drum.

7. A method as in claim 4 including the step of transferring the filter components between flutes of rotating drums during forming.

8. A method of making filter rods each having a predetermined arrangement of filter components, the method comprising:
repetitively establishing sets of filter rod components along a flute of a rotating drum in accordance with the predetermined arrangement;
thereafter moving the repetitively established sets along a conveyance path by transferring the repetitively established sets along a plurality of drums; and
feeding particulate material to each set at a location along the conveyance path.

9. A method of manufacturing cigarettes comprising the steps of combining tobacco rods with the filter rods made in accordance with the method of claim 8.
